(19) United States
(12) Patent Application Publication
(10) Pub. No.: US 2002/0066195 A1
(43) Pub. Date: Jun. 6, 2002

(54) Hand drawing machine

(76) Inventor: Lay Gwon, Astoria, NY (US)

Correspondence Address: Richard C. Litman, P.O. Box 15305, Crystal City Station, Arlington, VA, 22215-0035, US

(21) Appl. No.: 10/058,934

(22) Filed: Jan. 30, 2002

Related U.S. Application Data
(62) Division of application No. 09/520,326, filed on Mar. 7, 2000.

(51) Int. Cl. B43L 7/08

(52) U.S. Cl. 33/437

(57) ABSTRACT

A hand drawing machine which is used to copy a planar image by hand onto a piece of paper or other suitable flat material. A tracking means for correlating movement of both styluses in the horizontal direction and a guiding means for correlating movement of both styluses in the vertical direction are utilized in both embodiments. The hand drawing machine of either embodiment of the present invention utilizes a framework for holding the hand drawing machine steady relative to a flat surface enabling a user to place the hand drawing machine on any suitable flat surface such as a drafting table. The tracking means is slidably attached to the guiding means forming an assembly. The assembly is firmly attached to the framework by an attachment means. The tracing stylus holder is in mechanical communication with the marking stylus holder, through the assembly, such that any movement of the tracing stylus holder reproduces a corresponding movement in the marking stylus holder. In the first embodiment, the guiding means is a guide rail, the tracking means is a tracking arm, a casing retractably engages the tracking arm and slidably engages the guide rail, and the stylus holders are attached to the tracking arm. In the second embodiment, the guiding means is a first guide arm, a second guide arm, and a vertical gear assembly, and the tracking means is a first tracking arm, a second tracking arm, and a horizontal gear assembly. A stylus holder is disposed on the front end of each of the guide arms.

### BACKGROUND OF THE INVENTION

1. Field of the Invention

The present invention relates to hand drawing machines for reproducing a planar image, and more particularly to a mechanical hand drawing machine for reproducing a planar image which is the same size, larger, or smaller than the original and is without undesired distortions.

2. Description of the Related Art

Devices for hand tracing a planar image exist. The best-known device is tracing paper which requires the user to place the tracing paper over the image and draw directly on the tracing paper. The primary disadvantage of tracing paper is that the paper itself is not of high quality and is very flimsy so that the resulting picture is of unsuitable, poor quality. Mechanical devices also exist for reproducing a planar image. These devices are typically difficult to use because of their limited range of movement, and their unstable construction. Likewise, either the mechanical devices of the prior art cannot change the dimensions of the planar image, or they can only enlarge or shrink the image but not both. Additionally, the prior art devices that permit the enlargement or shrinkage of the image unavoidably distort the image.

U.S. Pat. No. 1,320,321 issued to Crowley, Jr. on Oct. 28, 1919 discloses a planigraph which is utilized to copy pictures, designs and other planar images. The planigraph has a fixed arm and a movable arm; the movable arm is utilized to reproduce an image but only moves relative to the fixed arm; therefore, the invention of Crowley changes the dimensions of the original image and distorts the image by either elongating or widening it. U.S. Pat. No. 3,721,008 issued to Frank on Mar. 20, 1973 describes a device (a marker and tracking arm) which is a pen with an arm extending therefrom having a tracking point that follows an identical track as the point of the pen. The invention of Frank produces an image of the same dimensions as the image traced but is inherently unstable. U.S. Pat. No. 4,945,643 issued to Goldfarb on Aug. 7, 1990 shows an amusement apparatus for drawing a distorted caricature by tracing an original photograph or other planar image; the apparatus enlarges the image in one direction, but copies without enlargement in an orthogonal direction. The invention of Goldfarb has a tracing arm which has a tracing stylus at one point, a drawing-implement holder at another point, and a longitudinal track along another part of the arm; the track engages a pivot that in effect resolves all tracing motions into radial components without size change and rotary components with size changes. None of these inventions have the qualities of the present invention in total; either they distort the image or are not designed for detailed tracing.

U.S. Pat. No. 3,786,567 issued to Dangay, deceased et al. on Jan. 22, 1974 shows an apparatus for drawing the isometric perspective view of an object. The apparatus has a fixed support on which the flat view of the object is provided, a rotatable support for a drawing sheet and positionable in one of three positions spaced 120°, a follower for following a flat view, a tracer displaceable over the rotatable support and means linking the follower and tracer such that displacements of the follower in two perpendicular directions cause displacements of the tracer that are perpendicular but in the ratio of one over the square root of three, the linkage means for displacements in one reference direction comprising rotary means, the effective diameters of which are in the ratio of one over the square root of three. The invention of Dangay facilitates the hand drawing of an isometric perspective view of an object; it does not change the dimensions of the object nor does it depict the same view. Also, the invention of Dangay is much more complicated than the current invention, having been conceived for a distinctive utility which is inherently different from the present invention.

U.S. Pat. No. 3,483,622 issued to Forster on Dec. 16, 1969 discloses a drawing apparatus which is designed for the production of stereoscopic images. The drawing apparatus has a drawing mechanism attached to a drawing board having a pliable support with two rollers, a plate to guide the support, and a guide rail to guide the supports. The drawing apparatus of Forster reproduces a second image while the user is drawing a first image such that the first and second image are slightly different in order to create the illusion of three dimensions. The invention of Forster is not suited for the purpose of the present invention and has no means provided for changing the size of a copied image.

In an analogous technique, wood carving machines exist which are designed to reproduce an image in wood. These devices may have parallel arms having a tracing stylus on one arm and a cutting implement on another. U.S. Pat. No. 2,185,011 issued to Anderson Jun. 30, 1938 shows a wood carving machine which is adapted for carving individual facsimiles of any particular work pattern that the user may desire to copy. U.S. Pat. No. 3,831,575 issued to Menghini on Aug. 27, 1974 discloses a semi-automatic apparatus for reproducing relief images on solid bodies which has a sensing member and a working tool member; the sensing member traces the three-dimensional image and the working tool member reproduces the image. Wood carving devices are not appropriate for tracing images onto paper as they are designed to reproduce a three dimensional image.

None of the above inventions and patents, taken either singularly or in combination, is seen to describe the instant invention as claimed. Thus, a hand drawing machine solving the aforementioned problems is desired.

### SUMMARY OF THE INVENTION

The present invention is a hand drawing machine which can be used to trace a planar image in intricate detail. The hand drawing machine has a means for tracking the planar image, a means for marking the traced image onto a piece of paper, and a mechanical means for communicating between the tracking means and the marking means. A first embodiment of the invention is used to produce a traced image equal in size to the original. A second embodiment of the device is used to trace the image in various sizes. The mechanical means of the second embodiment can be alternatively set to reproduce an image of equal size to the original, to enlarge the image, to shrink the image, or to modify the image either enlarging, shrinking or maintaining the same dimensions in both the vertical and horizontal directions separately. Also, the second embodiment permits the user to modify the dimensions of the reproduction while tracing the planar image resulting in a very detailed abstract drawing.

Accordingly, it is a principal object of the invention to reproduce a planar image by hand. The invention allows a user to trace a planar image such as a photograph, drawing or similar image easily. The invention is designed to permit very detailed reproduction of the planar image allowing accurate depiction of the finest details.

It is another object of the invention to change the dimension of the planar image making it larger or smaller. One embodiment of the present invention allows the user to enlarge or reduce the size of the image reproduced. It also facilitates the changing of the horizontal and vertical dimensions separately. Likewise, changing the vertical and horizontal dimensions is possible while working on the same piece of artwork.

It is a further object of the invention to eliminate distortions when copying an image by hand. The present invention facilitates making a copy of a planar image without distortions in either the width or height of the image copied if desired.

Still another object of the invention is to provide a hand drawing machine which is a sturdy device that is not wobbly. The construction of the present invention is sturdy, and does not shake or otherwise reduce the quality of the image reproduced. The sturdiness of the apparatus allows the user to make intricate tracings of a planar image.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental view of a first embodiment of a hand drawing machine according to the present invention.

FIG. 2 is a top plan view of the embodiment of the hand drawing machine depicted in FIG. 1.

FIG. 3 is a fragmented view of a casing, partly broken away, utilized with the hand drawing machine depicted in FIG. 1.

FIG. 4 is a perspective view of a second embodiment of a hand drawing machine according to the present invention.

FIG. 5 is an exploded view of a gear assembly which controls horizontal movement of tracking arms according to the second embodiment of the hand drawing machine depicted in FIG. 4.

FIG. 6 is an exploded view of a gear assembly which controls vertical movement of guiding arms according to the second embodiment of the hand drawing machine depicted in FIG. 4.

Similar reference characters denote corresponding features consistently throughout the attached drawings.

### DETAILED DESCRIPTION OF THE PREFERRED EMBODIMENTS

The present invention is a hand drawing machine which is used to copy a planar image by hand onto a piece of paper or other suitable flat material. Two primary embodiments of the present invention are illustrated herein. The first embodiment facilitates tracing the planar image with the same dimensions as the original without distortions. The second embodiment traces the planar image alternatively with the same dimensions as the original image, or with larger or smaller dimensions than the original. The second embodiment may also be set to trace the image with mixed dimensions either producing larger or smaller dimensions in the horizontal line or the vertical line relative to one another thus permitting a single tracing to have multiple dimensions therein.

Either embodiment of the hand drawing machine, as discussed in greater detail hereinafter, has a first stylus holder and a second stylus holder which function as a tracing stylus holder and a marking stylus holder respectively. The tracing stylus holder is designed to grip a tracing stylus which is guided over the original planar image to trace the image. The tracing stylus may be a needle or any other suitable pointing instrument. The marking stylus holder grips a marking stylus which may be a pen, a pencil, or other implement that can be used to mark a planar image on a suitable material. Reversing the location of the tracing stylus and the marking stylus is possible. Likewise, the tracing stylus may be replaced by a marking stylus permitting the creation of two complementary planar images simultaneously. Also, the tracing styluses may be identical differing only in their function. Further, a tracking means for correlating movement of both styluses in the horizontal direction and a guiding means for correlating movement of both styluses in the vertical direction are utilized in both embodiments. The term horizontal herein refers to the parts of the invention used to control or correlate motion in the horizontal direction of the planar image. Likewise, the term vertical herein refers to the parts of the invention used to control or correlate motion in the vertical direction of the planar image.

The hand drawing machine of either embodiment of the present invention utilizes a framework for holding the hand drawing machine steady relative to a flat surface enabling a user to place the hand drawing machine on any suitable flat surface, such as a drafting table. The tracking means is slidably attached to the guiding means, forming an assembly. The assembly is firmly attached to the framework by an attachment means. The tracing stylus holder is in mechanical communication with the marking stylus holder through the assembly, such that any movement of the tracing stylus holder reproduces a corresponding movement in the marking stylus holder.

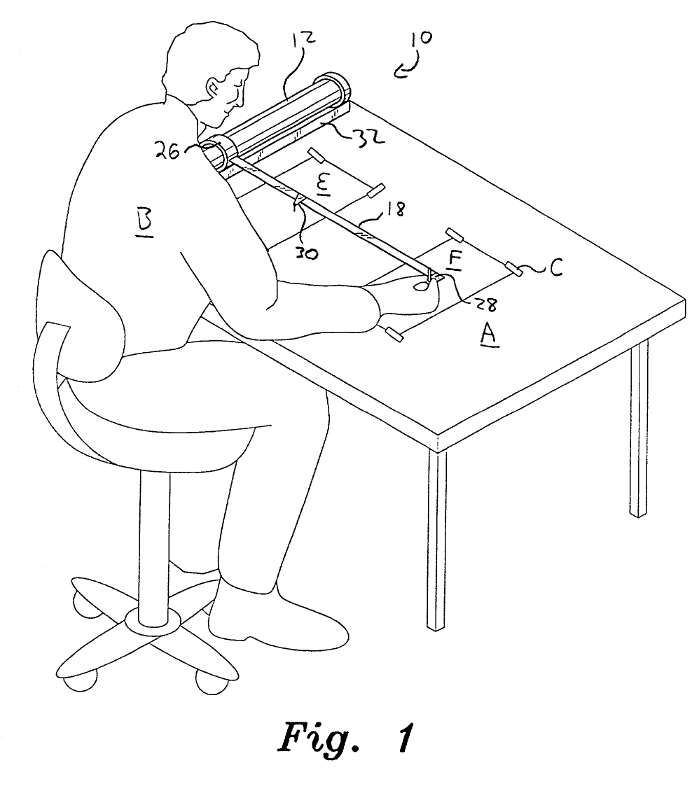

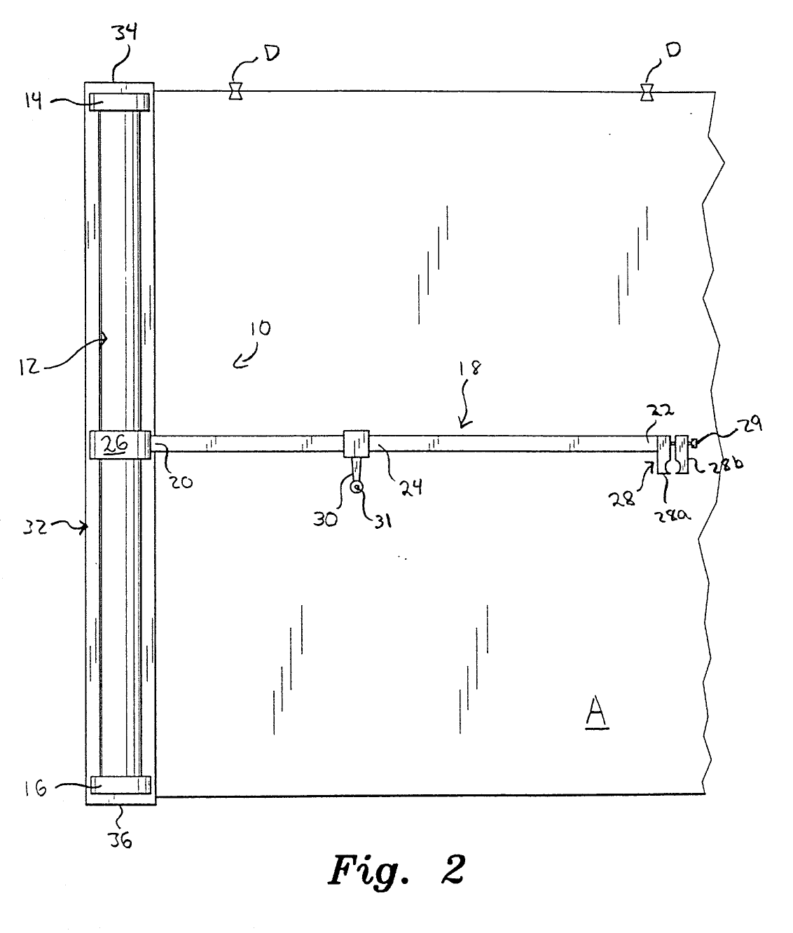

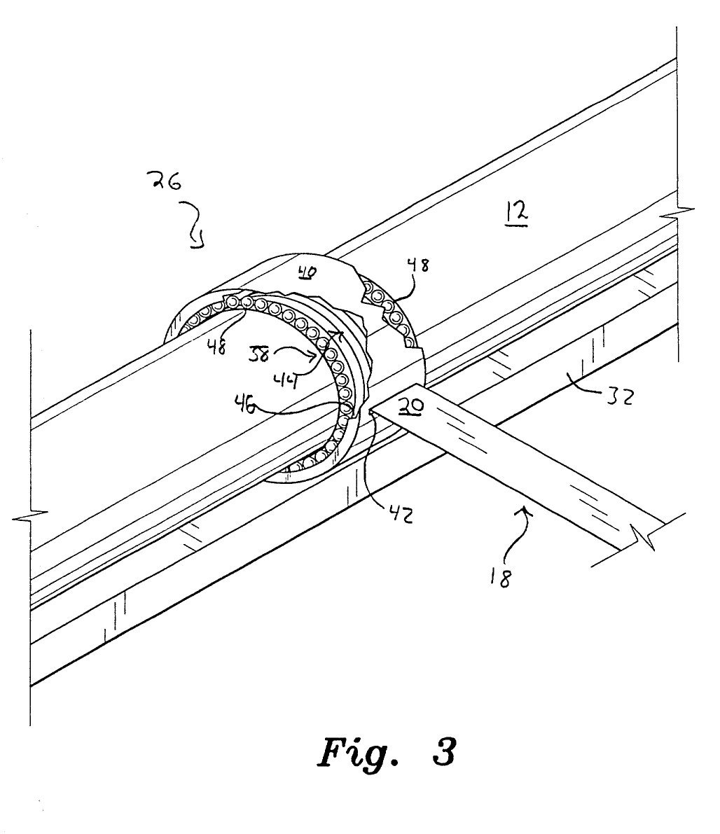

The first embodiment of the present invention is depicted in FIGS. 1, 2 and 3. FIG. 1 shows an environmental view of the hand drawing machine 10 according to the first embodiment. A user B is shown using the first embodiment of the present invention in FIG. 1. The planar image E to be traced and the blank paper F are shown removably affixed to the table A by tape C. Other conventional means of affixing the planar image E and the paper F to the table A are also contemplated. For example, paper clips D shown in Fig. 2 may be used to hold the planar image E and paper F in place.

FIG. 2 is a plan view of the first embodiment as seen from the top. The guiding means of this embodiment is a guide rail 12 which has a first terminus 14, a second terminus 16, a length extending from the first terminus 14 to the second terminus 16, and a girth. Girth refers to the exterior surface of the guide rail 12 encompassing the perimeter thereof laterally. The guide rail 12 of the first embodiment need not be cylindrical in shape, as shown in the figures, but must have a uniform girth that does not vary in dimensions from the first terminus 14 to the second terminus 16.

The tracking means of the first embodiment is a retractable tracking arm 18 having a first end 20, a second end 22, and a middle region 24. The retractable tracking arm 18 is slidably attached to the guide rail 12 via a casing 26 by a slidable attachment means such that the first end 20 of the tracking arm 18 is retractably engaged in the casing 26. The marking stylus holder 28 is attached to the second end 22, and the tracing stylus holder 30 is attached to the middle region 24 of the tracking arm 18. The casing 26 receives the first end 20 of the retractable tracking arm 18 by a retracting means permitting the retractable tracking arm 18 to move freely in and out of the casing 26. The retracting means of the present invention is conventional, well known in the art of mechanical devices, and similar to a retractable measuring tape except that the retractable tracking arm 18 is not automatically retracted. The tracking arm 18 moves only when a user B thereof moves either of the stylus holders 28 and 30. Movement of either stylus holder results in a corresponding movement in the other stylus holder.

The marking stylus holder 28 is preferably a two-part clamp having a first half 28a, a second half 28b, and a screw 29. The first half 28a of the clamp is firmly attached to the second end 22 of the tracking arm 18, as shown in FIG. 2. The second half 28b of the clamp is held in place relative to the first half 28a by the screw 29. The screw 29 serves to tighten the first half 28a and the second half 28b of the clamp around any type of marking stylus, thus holding the marking stylus firmly in place. The two halves of the clamp are conventional clamp jaws requiring only that they can firmly hold a marking stylus. Any analogous device suitable for holding a marking stylus is contemplated by the present invention, and may be substituted for the marking stylus holder 28 as shown provided that the device holds the marking stylus firmly, not permitting movement of the marking stylus independently of the tracking arm 18.

The tracing stylus holder 30 is preferably a one piece apparatus having an elongated arm with an aperture 31 for receiving a needle or other tracing stylus therethrough at one end, and being connected to the middle region 24 of the tracking arm 18 at the other end, as shown in FIG. 2. The tracing stylus holder 30 is attached to the middle region 24 of the tracking arm 18 in such a manner as to prevent the tracing stylus from moving independently of the tracking arm 18. Alternatively, the tracing stylus holder may be another marking stylus holder wherein the first half is attached to the tracking arm with the second half being engaged to the first half by a screw in front of the tracking arm so that the first half is longer than the second half permitting attachment of another marking stylus instead of a tracing stylus thereto (not shown). The invention herein contemplates any suitable stylus holder. Likewise, the stylus holder 30 may be removable permitting the tracking arm 18 to be fully retracted into the casing 26 for storage purposes. The tracing stylus holder 30 and the marking stylus holder 28 may be reversed so that the tracing stylus holder 30 is attached to the second end 22 of the tracking arm 18 and the marking stylus holder 28 is attached to the middle region 24 of the tracking arm 18.

The framework of the first embodiment is a base 32 having an elongated shape with a first end region 34 and a second end region 36. The retractable tracking arm 18, the guide rail 12, and the casing 26 altogether form an assembly. This assembly is attached to the base 32 via the guide rail 12. The first terminus 14 of the guide rail 12 is attached to the first end region 34 of the base 32, and the second terminus 16 of the guide rail 12 is attached to the second end region 36 of the base 32. The base 32 is placed on a drafting table A, or other suitable flat surface, as shown in FIGS. 1 and 2. The assembly is held firmly in position by the base 32 and does not wobble.

The casing 26 is shaped to fit around the girth of the guide rail 12 and flush thereto. The casing 26 has an inner periphery 38, an outer periphery 40, an opening 42, a chamber 44, and at least two groves 46 encircling the inner periphery 38 of the casing 26. The casing 36 slidably encompasses the girth of the guide rail 12 and has a plurality of ball bearings 48 disposed within the grooves 46 and along the inner periphery 38 thereof. The plurality of ball bearings 48 permits the casing 26 to slide along the guide rail 12 lengthwise but not laterally preventing movement around the guide rail 12. The first end 20 of the retractable tracking arm 18 is retractably engaged within the casing 26 through the opening 42 therein. The first end 20 and the region of the retractable tracking arm 18 contiguous therewith are held within the chamber 44 of the casing 26 when retracted into the casing 26.

The user B traces the planar image E with the tracing stylus engaged in the tracing stylus holder 30 reproducing the tracing on the paper F or other suitable material with the marking stylus engaged in the marking stylus holder 28. The retractable tracking arm 18 is static except when moved by the user B. The casing 26 is a mechanical means of communication between the tracking arm 18 and the guide rail 12. The hand drawing machine of the first embodiment permits tracing in a complete 360 degree radius of the planar image E without modifications or distortions of the planar image E as traced.

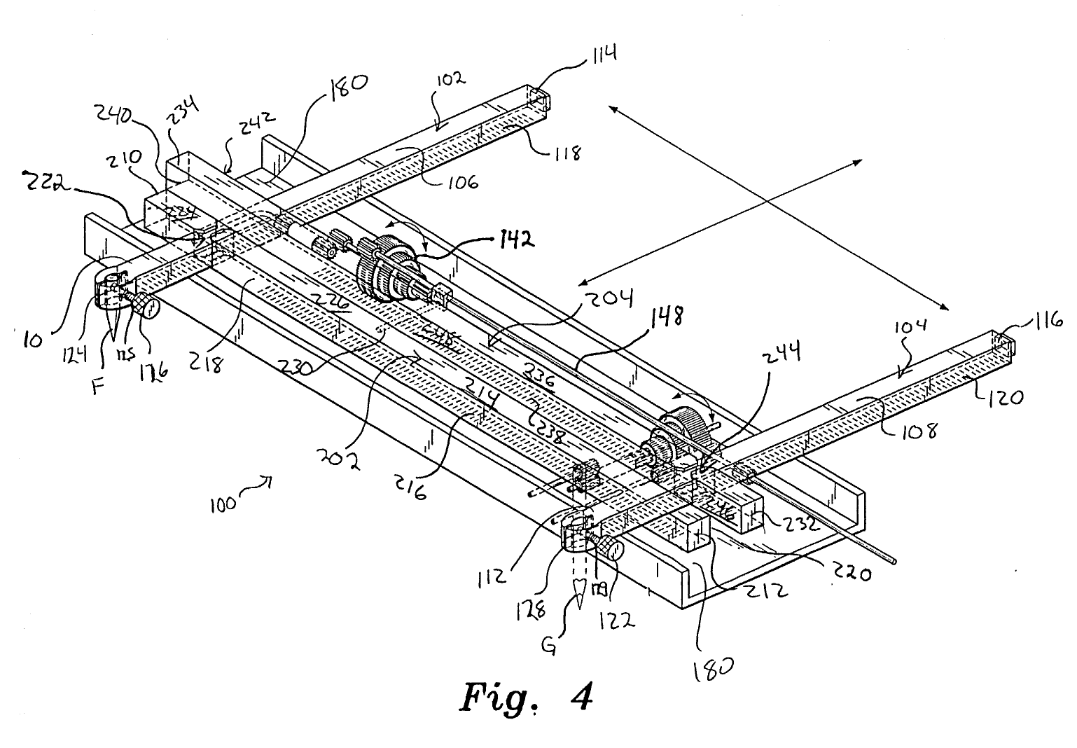

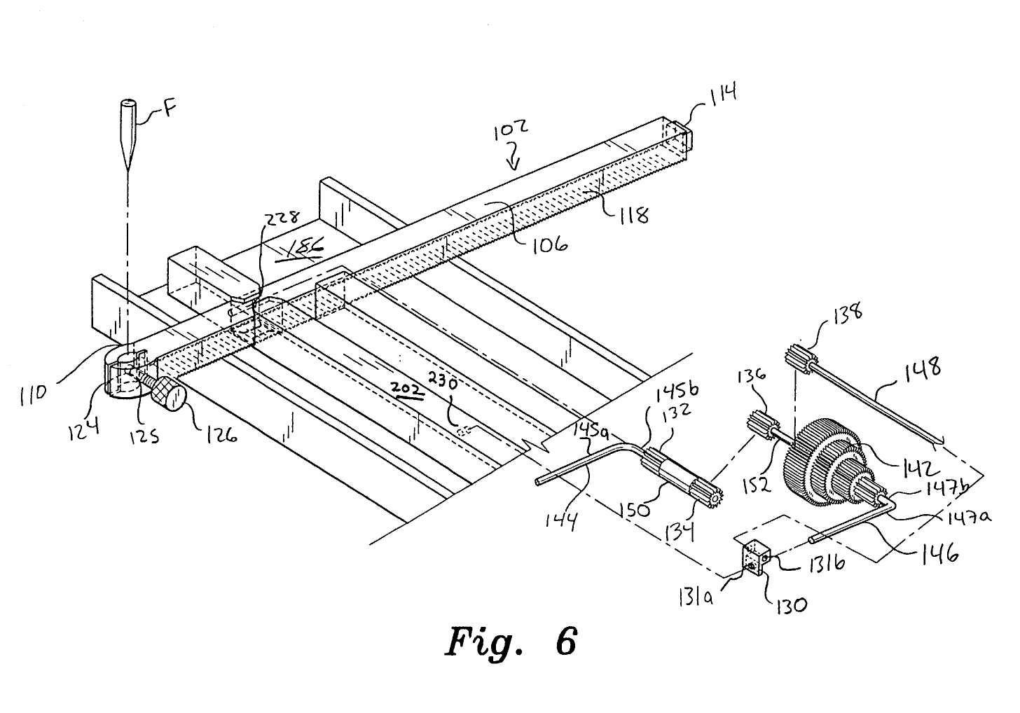

The second embodiment of the hand drawing machine of the current invention is depicted in FIGS. 4, 5 and 6. FIG. 4 shows the entire hand drawing machine 100 of the second embodiment. The guiding means of this embodiment is composed of a first guide arm 102, a second guide arm 104, and a vertical gear assembly. The vertical gear assembly is shown most clearly in FIG. 6. The first guide arm 102 has a length, a girth, a top 106, two sides, a front end 110, a back end, and a bottom 118 having gear teeth defining a rack disposed thereon preferably the entire length of the bottom 118 from the front end 110 to the back end 114. The second guide arm 104 has a length, a girth, a top 108, two sides, a front end 112, a back end 116, and a bottom 120 having gear teeth defining a rack disposed thereon preferably the entire length of the bottom 120 from the front end 112 to the back end 116.

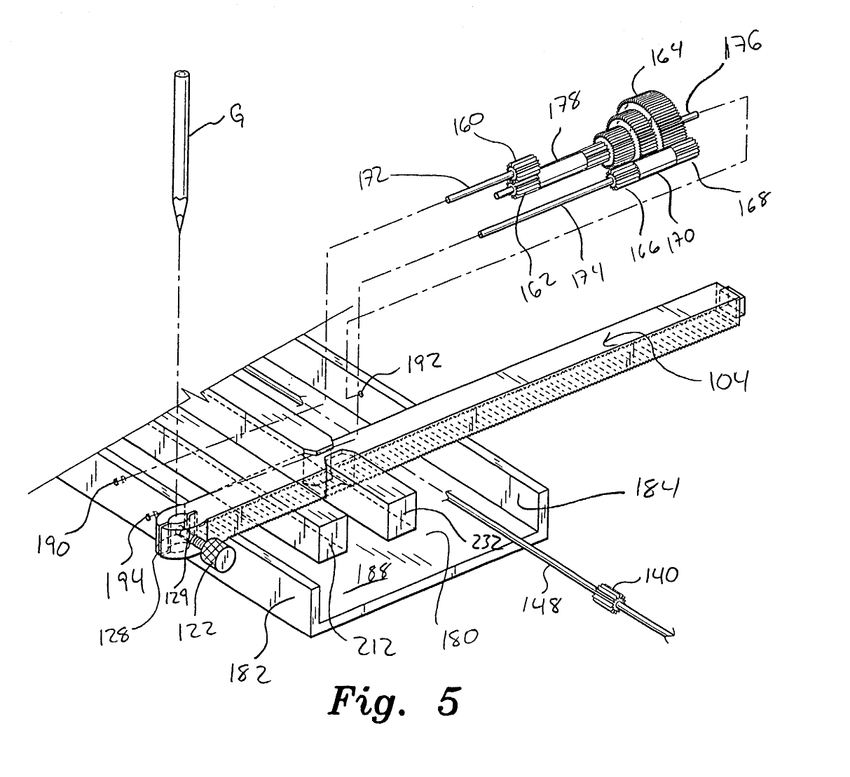

The front end 110 of the first guide arm 102 has a slit 124, with a cylindrical center therethrough from top 106 to bottom 118, and a transverse opening 125 through one side into the cylindrical center of the slit 124 for receiving a clamping screw 126 through the opening 125 into the slit 124 thereby forming a stylus holder, as seen most clearly in FIG. 6. The front end 112 of the second guide arm 104 has a slit 128 with a cylindrical center therethrough from top 108 to bottom 120, and a transverse opening 129 through one side into the cylindrical center of the slit 128 for receiving a clamping screw 122 through the opening 129 into the slit 128, thereby forming a stylus holder, as seen most clearly in FIG. 5. The two stylus holders thus formed are identical in every way. Preferably, a tracing stylus F is placed in the cylindrical center of the slit 124 of the front end 110 of the first guide arm 102 and secured into place by the screw 126. A marking stylus G is placed in the cylindrical center of the slit 128 of the front end 112 of the second guide arm 104 and secured into place by the screw 122. The tracing stylus F and the marking stylus G may be reversed or two marking styluses may be used.

The tracking means is composed of a first tracking arm 202, a second tracking arm 204, and a horizontal gear assembly, as shown in FIG. 5. The first tracking arm 202 has a length, a first end 210, a second end 212, a top 214, a bottom 216, a first side 218, a second side 220, a slot 222 dividing the length into a first section 224 and a second section 226, the first section 224 being shorter than the second section 226, a first opening 228 through the second side 220 of the first section 224, and a second opening 230 through the second side 220 of the second section 226. The slot 222 of the first tracking arm 202 is shaped to slidably receive the girth of the first guide arm 102 therethrough, as shown in FIGS. 4 and 6. The bottom 216 of the second section 226 of the first tracking arm 204 has teeth running along the length thereof defining a rack.

The second tracking arm 204 has a length, a first end 232, a second end 234, a top 236, a bottom 238, a first side 240, a second side 242, a slot 244 dividing the length into a first section 246 and a second section 248, the first section 246 being shorter than the second section 248. The slot 244 of the second tracking arm 204 is shaped to slidably receive the girth of the second guide arm 104 therethrough, as shown in FIGS. 4 and 5. The bottom 238 of the second section 248 of the second tracking arm 204 has teeth running along the length thereof defining a rack.

It is understood that gears herein are centrally engaged on the shafts through the axis of the gears. The vertical gear assembly, shown in FIG. 6, consists of a plurality of vertical gears, a plurality of vertical shafts, and a clip 130. The plurality of gears includes a first vertical gear 132, a second vertical gear 134, a third vertical gear 136, a vertical engaging gear 138, a vertical guiding gear 140 shown in FIG. 5, and a vertical gear stack 142. The vertical gear stack 142 is composed of a plurality of gears wherein each gear shares a common axis, is rigidly attached to one another, and has a different diameter, as shown in FIG. 6. The plurality of shafts includes a first vertical shaft 144, a second vertical shaft 146, and a third vertical shaft 148. The clip 130 has a first cylindrical opening 131a and a second cylindrical opening 131b extending through the clip 130 in separate planes, perpendicular to one another, as shown.

The first vertical gear 132 is connected to and separated from the second vertical gear 134 by a vertical spacer 150 forming one rigid entity referred to as a first vertical gear body. The first vertical shaft 144 is bent to form two arms, a first arm 145a and a second arm 145b, which are at right angles to one another, and the first vertical gear body is rotatably mounted on the second arm 145b of the first vertical shaft 144 such that gears 132 and 134 rotate simultaneously about shaft 145b. The first arm 145a of the first vertical shaft 144 rigidly engages the first opening 228 in the first tracking arm 202 and is at a right angle thereto, so that the second arm 145b of the shaft 144 is parallel to the second section 226 of the first tracking arm 202.

The third vertical gear 136 is connected to and separated from the vertical gear stack 142 by a second vertical spacer 152 forming one rigid entity referred to herein as a second vertical gear body. The second vertical shaft 146 is bent to form two arms, a first arm 147a and a second arm 147b which are at right angles to one another. The second gear body is rotatably mounted on the second arm 147b so that third vertical gear 136 and vertical gear stack 142 rotate simultaneously about shaft arm 147b. The first arm 147a of shaft 146 is inserted through opening 131a in clip 130 and lodged in opening 230 of first tracking arm 202 with the third vertical gear 136 engaging the second vertical gear 134 such that any movement of the second vertical gear 134 produces a corresponding movement in the third vertical gear 136, and vice versa.

The vertical engaging gear 138 and the vertical guiding gear 140 are rigidly affixed to the third vertical shaft 148 at opposite ends thereto so that rotation of the vertical engaging gear 138 produces rotation of the vertical guiding gear 140, and vice versa. The third vertical shaft 148 is slidably engaged in the second cylindrical opening 131b of the clip 130 with the vertical engaging gear 138 and the vertical guiding gear 140 opposite the clip 130 such that the vertical engaging gear 138 can be brought in contact with any one of the plurality of gears making up the vertical gear stack 142 so that rotational movement of the vertical engaging gear 138 produces a corresponding rotational movement of the vertical gear stack 142 and vice versa.

As shown in FIG. 5, the horizontal gear assembly consists of a plurality of horizontal gears, and a plurality of horizontal shafts. The plurality of horizontal gears includes a first horizontal gear 160, a second horizontal gear 162, a horizontal gear stack 164, a horizontal tracking gear 166, and a horizontal engaging gear 168. The horizontal gear stack 164 is composed of a plurality of gears wherein each gear shares a common axis, is rigidly attached to one another, and has a different diameter. The plurality of gears in the horizontal gear stack 164 corresponds to the diameter and number of gears in the vertical gear stack 142.

The plurality of horizontal shafts includes a first horizontal gear shaft 174, a second horizontal gear shaft 172, and a third horizontal gear shaft 176. The second horizontal gear 162 is connected to and separated from the horizontal gear stack 164 by a first horizontal spacer 178 forming one rigid entity which is referred to herein as a first horizontal gear body. The horizontal tracking gear 166 is connected to and separated from the horizontal engaging gear 168 by a second horizontal spacer 170 forming one rigid entity which is referred to herein as a second horizontal gear body. The first horizontal gear 160 is rotatably mounted on the second horizontal gear shaft 172. The first horizontal gear body is rotatably mounted on the third horizontal gear shaft 176. The second horizontal gear body is rotatably mounted on the first horizontal gear shaft 174.

The framework is a frame having a flat bottom 180, a first lip 182, a second lip 184 opposite the first lip 182, a first terminus 186, and a second terminus 188. The second terminus 188 region of the frame has a first orifice 190 in the first lip 182, and a second orifice 192 in the second lip 184 opposite the first orifice 190, and a third orifice 194 in the first lip 182 adjacent the first orifice 190. The guiding means and the tracking means together form an assembly. The assembly is attached to the framework through the horizontal gear assembly whereby the second horizontal gear shaft 172 is rigidly inserted into the first orifice 190 so that shaft 172 does not rotate. The third horizontal gear shaft 176 is rigidly inserted into the second orifice 172 so that the horizontal gear stack 164 is closest to the second lip 184 and the second horizontal gear 162 engages the first horizontal gear 160 such that rotational movement in the first horizontal gear 160 produces rotational movement in the second horizontal gear 162 and vice versa. The first horizontal gear shaft 174 is rigidly inserted in the third orifice 194 such that the horizontal engaging gear 168 engages the horizontal gear stack 164 such that rotational movement of the horizontal engaging gear 168 produces rotational movement in the horizontal gear stack 164 and vice versa.

The assembly and the framework together enable mechanical communication between the stylus holders such that any movement in one stylus holder produces a corresponding movement in the other stylus holder. The mechanical communication has the first guide arm 102 being slidably engaged in the slot 222 of the first tracking arm 202 with the bottoms 118 and 216 of both the first guide arm 102 and the first tracking arm 202 being in the same direction, and the first end 110 of the first guide arm 102 being disposed adjacent to the first side 218 of the first tracking arm 202. The first guide arm 102 is placed across the first and second lips 182 and 184 of the frame, and are perpendicular thereto with the first tracking arm 202 in between the first and second lips 182 and 184. The bottoms 118 and 216 of the first guide arm 102 and of the first tracking arm 202 are downward adjacent to the flat bottom 180 of the frame, having the vertical gear assembly disposed between the first and second lips 182 and 184 of the frame. The teeth on the bottom 118 of the first guide arm 102 are in contact with the first vertical gear 132 such that any movement of the first guide arm 102 lengthwise produces a corresponding rotational movement in the first vertical gear 132 and vice versa. The teeth on the bottom 216 of the first tracking arm 202 are in contact with the first horizontal gear 160 such that any movement of the first tracking arm 202 lengthwise produces a corresponding rotational movement in the first horizontal gear 160 and vice versa.

The second guide arm 104 is slidably engaged in the slot 244 of the second tracking arm 204 with the bottoms 120 and 238 of both the second guide arm 104 and the second tracking arm 204 being in the same direction, and the first end 112 of the second guide arm 104 and the second tracking arm 204 being in the same direction. The first end 112 of the second guide arm 104 is disposed adjacent to the first side 240 of the second tracking arm 204. The second guide arm 104 is placed across the first and second lips 182 and 184 of the frame being perpendicular thereto with the second tracking arm 204 in between the first and second lips 182 and 184. The bottoms 120 and 238 of the second guide arm 104 and of the second tracking arm 204 are downward adjacent to the flat bottom 180 of the frame. The teeth on the bottom 120 of the second guide arm 104 are in contact with the vertical guiding gear 140 such that any movement of the second guide arm 104 lengthwise produces a corresponding rotational movement in the vertical guiding gear 140 and vice versa. The teeth on the bottom 238 of the second tracking arm 204 are in contact with the horizontal tracking gear 166 such that any movement of the second tracking arm 204 lengthwise produces a corresponding rotational movement in the horizontally tracking gear 166 and vice versa.

It is to be understood that the present invention is not limited to the embodiments described above, but encompasses any and all embodiments within the scope of the following claims.

I claim:

1. A hand drawing machine comprising:
a first stylus holder, and a second stylus holder;
a tracking means for correlating movement of both stylus holders in the horizontal direction;
a guiding means for correlating movement of both stylus holders in the vertical direction;
a framework for holding said hand drawing machine steady relative to a flat surface;
said tracking means being slidably attached to said guiding means in order to form an assembly;
said assembly being firmly attached to said framework by an attachment means; and
said first stylus holder being in mechanical communication with said second stylus holder, through said assembly, such that any movement of said first stylus holder reproduces a corresponding movement in said second stylus holder.

2. The hand drawing machine of claim 1, wherein:
said guiding means is a guide rail having a length, a first terminus, a second terminus, and a girth;
said tracking means is a retractable tracking arm having a first end, a second end, and a middle region;
a casing slidable on said guide rail, the first end of said retractable tracking arm being retractable into said casing;
retracting means for retracting said tracking arm in and out of said casing;
said first stylus holder is a tracing stylus holder for tracing and existing image, the tracing stylus holder being attached to the middle region of said tracking arm;
said second stylus holder is a marking stylus holder for drawing a copy of the existing image, the marking stylus holder being attached to said second end of said tracking arm.

3. The hand drawing machine of claim 2, wherein:
said casing is shaped to fit around the girth of said guide rail flush thereto, the casing having an inner periphery, an outer periphery, an opening, a chamber, and at least two groves encircling the inner periphery of the casing;
said casing further comprises a plurality of ball bearings disposed within the grooves along the inner periphery thereof, the plurality of ball bearings permitting said casing to slide along said guide rail lengthwise; and
the first end of said retractable tracking arm retract into said casing through the opening defined therein.

4. The hand drawing machine of claim 2, wherein said tracing stylus holder is a one piece apparatus having an elongated arm and two ends with an aperture for receiving a tracing stylus therethrough at one end and being connected to the middle region of said tracking arm at the other end perpendicular to said tracking arm and parallel to said guide rail.

5. The hand drawing machine of claim 2, wherein said marking stylus holder is a two-part clamp having a first half, a second half, and a screw, the screw extending transversely through the first half and the second half and attaching said clamp to the second end of said tracking arm, the first half and the second half defining jaws for holding a marking stylus.

6. The hand drawing machine of claim 2, wherein the positions of said marking stylus holder and said tracing stylus holder on said tracking arm are interchangeable.

7. The hand drawing machine of claim 2, wherein the tracing stylus holder is detachable.

8. A hand drawing machine for drawing a copy of an original image, comprising:
a) a U-shaped frame having an elongated flat bottom, a first vertical lip attached to one side of the flat bottom, and a second vertical lip attached to an opposing side of the flat bottom;
b) a first guide arm having a first end, a second end, and a bottom surface having a plurality of gear teeth therein defining a first rack, the first end having a first stylus holder defined therein;
c) a first tracking arm having a first slot defined therein and having a bottom surface with a plurality of gear teeth therein defining a second rack, said first guide arm being slidably disposed in the first slot normal to the first tracking arm;
d) a second guide arm having a first end, a second end, and a bottom surface having a plurality of gear teeth therein defining a third rack, the first end having a second stylus holder defined therein;
e) a second tracking arm having a second slot defined therein and having a bottom surface with a plurality of gear teeth therein defining a fourth rack, said second guide arm being slidably disposed in the second slot normal to the second tracking arm;
f) guide means attached to said frame for moving said second guide arm at a rate proportional to a rate of movement of said first arm; and
g) tracking means attached to said frame for moving said second tracking arm at a rate proportional to a rate of movement of said first arm.

9. The hand drawing machine according to claim 8, wherein said guide means comprises a gear train, including:
a) a first pinion mounted on a shaft fixedly attached to said first tracking arm, the first pinion engaging said first rack;
b) a second pinion engaging said third rack;
c) an elongated vertical adjustment shaft having a clip thereon, the second pinion being mounted on said elongated vertical adjustment shaft; and
d) a plurality of intermediate guide gears coupling said first pinion to said second pinion.

10. The hand drawing machine according to claim 9, wherein said plurality of intermediate guide gears further comprises:
a) at least one gear stack having a plurality of gears of progressively increasing diameter fixedly attached to each other;
b) an intermediate shaft, said gear stack being rotatably mounted on the intermediate shaft;
c) an intermediate vertical gear mounted on said elongated vertical adjustment shaft, the intermediate vertical gear engaging one of said plurality of gears on said gear stack; and
d) wherein said intermediate shaft is adjustably mounted in a hole defined in said clip, so that said intermediate vertical gear may aligned with one of said plurality of gears on said gear stack in order to adjust the vertical height of the copy.

11. The hand drawing machine according to claim 8, wherein said tracking means comprises a gear train, including:
a) a third pinion mounted on a shaft fixedly attached to said first vertical lip, the third pinion engaging said second rack;
b) a fourth pinion engaging said fourth rack, the fourth pinion being mounted on a shaft fixedly attached to said first vertical lip; and
c) a plurality of intermediate tracking gears coupling said first pinion to said second pinion.

12. The hand drawing machine according to claim 11, wherein said plurality of intermediate tracking gears further comprises:
a) at least one gear stack having a plurality of gears of progressively increasing diameter fixedly attached to each other;
b) an intermediate shaft fixedly attached to said second vertical lip, said gear stack being rotatably mounted on the intermediate shaft; and
c) an intermediate horizontal gear engaging one of the plurality of gears of said gear shaft, the intermediate horizontal gear being mounted on the same shaft as said fourth pinion.
